(19) United States
(12) Patent Application Publication
(10) Pub. No.: US 2014/0279649 A1
(43) Pub. Date: Sep. 18, 2014

(54) DEFINITIVE SYSTEM FOR DELIVERY ADDRESS ROUTING

(71) Applicant: BRITTANY VENTURES LLC, Brooklyn, NY (US)

(72) Inventors: MARK CHARLES ANGELILLO, NEW YORK, NY (US); ROBERT MIHRAN COX, BROOKLYN, NY (US)

(73) Assignee: BRITTANY VENTURES LLC, Brooklyn, NY (US)

(21) Appl. No.: 14/023,114

(22) Filed: Sep. 10, 2013

Related U.S. Application Data
(60) Provisional application No. 61/786,394, filed on Mar. 15, 2013.

(51) Int. Cl. G06Q 10/08

(52) U.S. Cl. CPC G06Q 10/083
USPC 705/330

(57) ABSTRACT

A system and methodology is presented for definitive routing of letters, packages and other physical deliveries to a user's preferred address by reference to personal universal address. The object of the invention is to allow recipients to centrally control and confirm the desired receiving address for various types of deliveries, by creating a user-managed database linking physical addresses to secure personal communications addresses, such as cell phone numbers and electronic mail addresses.

### CROSS REFERENCE TO RELATED APPLICATIONS

The present application claims the benefit of U.S. Provisional Application 61/786,394 filed Mar. 15, 2013.

### FIELD OF THE INVENTION

The field of the present invention generally relates to handling virtual addresses and managing shipping and receiving.

### BACKGROUND OF THE INVENTION

Collecting correct shipment information is highly useful to companies and individuals. Mistakes in addressing physical goods can be very costly. Shipping costs incurred because of improper addressing can effectively treble the cost, potentially requiring a package to be returned to sender at their own expense before being properly resent to the intended recipient. In some particular circumstances, a time sensitive shipment can be substantially delayed, resulting in missed deadlines and commercial and personal interruptions. When a shipment contains private, privileged, or sensitive materials, misdirected delivery can result in exposure of this information publicly. When a shipment contains biological or chemical samples, food or other environmentally sensitive contents misdirected delivery can result in the spoilage of the contents.

Another set of circumstances also warrant consideration. Given increasing concerns about privacy, there are times where a person and even a business may prefer to use a package delivery or postal box address in lieu of a personal physical address. In larger companies, a person may designate a particular corporate location or internal mail distribution center for delivery. Likewise, some individuals may wish to have particular deliveries made to one or another among their common addresses—namely their work address, primary residence address, and possibly even, in some lucky cases, at a second home.

In short, given the proliferation of means of contact, telephones, SMS text messages, electronic messaging accounts (such as skype or AIM), electronic mail, personal addresses, and mailing addresses, the sheer volume of contact information required to be maintained has become staggering, and although the highest quality of information would tend to be that closest to use (i.e. active customers and suppliers or close family and friends), the fact that this information is separately maintained in multiple instances by each company on behalf of the contactee creates hours upon hours of administrative work required each time any individual changes a particular contact detail, moves, changes jobs, etc.

In light of public concern over financial security and personal privacy it is clear that merchants should not really require to know the actual shipping and billing address of their customers to complete a transaction. Only those actually delivering a package—namely professional delivery services (e.g. USPS, UPS, FedEx) and companies that manage their own deliveries (be they florists, pizza delivery or corporate trucking fleets)—actually need to know the locations where these products will be delivered.

### SUMMARY OF THE INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

In overcoming the above disadvantages associated with prior art, we describe a universal system of addressing physical mail by reference to a database that looks up the appropriate physical address by reference to an individual/company identifier (e.g. email address or cell phone or office number or QR Code or RFID) to route mail and packages.

In a further preferred embodiment of the invention, the database is maintained via direct user contact. The means of unique identification is a communication address (email/SMS/phone) by which the recipient can be cheaply, quickly, and conveniently contacted to initially provide or later confirm or update their preferred delivery address or addresses.

In an embodiment of the present invention, the personal universal address may be used to autocomplete shipping/billing/address information based on the personal universal address itself or an email/phone number associated with it.

In an embodiment of the present invention, the personal universal address may be used to simplify addressing envelopes where such a system confirms (or previously confirmed) recipients preferred address.

Embodiments of the present invention allow for other shippers and delivery services to have access to a user's shipping information through the API, assuming they have been authenticated and given permission. This approach saves the recipient the trouble of updating shipping information across a variety of shippers.

Personal privacy may be maintained by allowing business and other correspondence to be addressed without revealing the recipient's physical location to strangers.

In an embodiment of the present invention, the accuracy of ultimate delivery information is confirmed using SMS/voice recognition/email, whereby the user can initially confirm the preferred connection to personal/company ID. Some further embodiments can distinguish automatically between PO Box and courier addresses because FEDEX & UPS & DHL do not deliver to PO Box addresses.

### BRIEF DESCRIPTION OF THE DRAWINGS

Preferred and alternative examples of the present invention are described in detail below with reference to the following Figure drawings:

FIG. 1 illustrates a network connecting servers, shippers, and various devices in accordance with an embodiment of the present invention;

FIG. 2 illustrates the process of physical address lookup;

FIG. 3 illustrates a network connected device in accordance with an embodiment of the present invention;

FIG. 4 illustrates a network connecting a data cluster through an API in accordance with an embodiment of the present invention;

### DETAILED DESCRIPTION

One exemplary embodiment of the present invention could work as a special “off the map” zip code space. Therein, any zip code starting with “67” (for example) would map to this space, and would trigger a lookup. Addresses from there could be customized, with vanity addresses available for a fee.

In a preferred embodiment of the present invention, FIG. 1 illustrates a system 100 for handling virtual addresses and managing shipping wherein users use their client devices [102, 104] to access the personal universal address server 106 over a network 108. Typically, this network 108 will be the Internet but it could be a public or private network and the network connection to the network may be a wireless or wireline connection. In an embodiment of the invention, the server may be a web server but the invention is not so limited. It may also be a server that functions as a backend to a special-purpose application or app that runs on the client devices [102, 104] and can access the server 106 to send and receive information to/from the database 110. The database 110 communicates to the server 106 through a network connection. It may directly communicate with the server 106 or it may communicate with the server 106 through the network 108. The database 110 may be implemented using any common database software including but not limited to Oracle or MySQL. The database 110, like the server 106, also runs an operating system, typically an implementation of the Unix or Linux OS or the Windows operating system or Macintosh server. The client devices [102, 104] may be a smartphone, a tablet computer like an iPad, a laptop, or a desktop system. The client devices [102, 104] may also be a specially purposed kiosk or end-point system specially designed to handle shipping issues. The client devices [102, 104] may also run an operating system like iOS for iPads and iPhones and the Android operating system for other smartphones. The laptop and desktop devices may run a version of Linux, or the Windows, or Macintosh OS.

In an embodiment of the present invention, regardless of the type of client device, each device includes, at a minimum, a network connection, some type of input subsystem (like a touchscreen, keyboard, mouse, trackpad, microphone, keypad, camera, etc.), a display, and the necessary microprocessors, and memory to run the device OS and either the app or a web browser. The network connection may be a wired network connection (like an Ethernet connection) or wireless network connection, like a cellular phone connection (using a standard such as 3G or 4G), or a WiFi connection.

A shipper's computer 112 is also connected to the network 108 via a network connection. The network connection may be either wireless or wireline and may use any of the standards previously mentioned to handle communications between the shipper's computer 112 and the network 108. The shipper's computer 112 may also include a printer connected to it that is capable of printing shipping labels. The shipper's computer 112 may be similarly outfitted as the client devices [102, 104] previously mentioned.

In an embodiment of the present invention, 200 in FIG. 2, a user wishing to acquire a personal universal address (PUA) accesses either the website of the server or downloads the PUA app to his client device. The remaining portion of the process will be discussed as if the user is accessing the server through an app but the reader will appreciate that the same steps can easily be accomplished by accessing the server through a web browser.

When the user first uses the application, it prompts the user to enter a PUA 202. If the PUA is already taken, the system will notify the user to choose another PUA. The user may choose any PUA. The PUA may be a unique identifier already associated with the user such as an email address or phone number. The user may also make up a PUA.

Once the user has chosen a PUA, he may be prompted to enter a password. The PUA and the password allow the user to log into the system in the future. Once the PUA and the password are selected, the user is prompted to enter the physical addresses 202 to associate with the PUA. If the user enters more than one physical address, the application may prompt him to give rules about when to use a particular physical address. For instance, a user may enter a rule to use a certain physical address for a certain part of the year but not other parts of the year. This may be useful if the user has a vacation home. Other rules may be based off the identity of the sender. For instance, personal packages from shippers like Amazon may be sent home while shippers associated with the user's business may be sent to the user's business physical address.

If the user so chooses, he may keep his PUA private or only share it with a select group of contacts. To aid in process of uploading contacts into the system, the user may import his contacts from a social network such as LinkedIn or Facebook or upload his contacts from a contacts program. He may also transfer his contacts from an email program or contacts program on a mobile device like a smart phone.

The app may also prompt him to add shippers from a list of well known shippers including the United States Postal Service, UPS, FedEX, DHL, and other private and public package and letter carriers. The list may also include popular e-commerce sites and retailers including companies like Macy's, Walmart, Target, Amazon, and Dell. The user may also directly add contacts, for example, by adding the contact information in a text box and submitting it. As the user adds contacts, he builds a list of contacts maintained by the application. These contacts are then accessible and searcheable by the user and contacts may be deleted and disabled.

Alternatively or in addition to the previously described embodiments, the application may prompt the user to select a security number or PIN. This PIN may be handed out by the user to shippers whom he has not placed on his contact list. The shippers may then use the user's PUA and the PIN to access the user's physical address. This PIN may be changed as many times as the user wants without having to change his PUA.

Once the user is finished, he saves all of his settings and is ready for shippers to use his PUA. His data is stored in a database associated with the server 204. If he would like to update his information, he uses the app to login using his PUA and his password. From there, he is prompted with options to change his physical addresses, disable his PUA, alter his contacts list or his PIN. He may also change the rules for when to ship to which physical address.

In an embodiment of the present invention, when a user is visiting an ecommerce website, he may enter his PUA instead of his physical address. The shipper, assuming the shipper is in the user's contacts list, accesses the server and retrieves the physical address of the user.

In an embodiment of the present invention, the shipper is given either the PUA or the PUA and the PIN from the user. Typically, this information is given in lieu of a physical address on a shipping form (either electronic or paper). The shipper then takes the PUA and possibly the PIN and sends it (or them) to the PUA shipping server. In an embodiment of the present invention, the PUA and the PIN are sent in such a format that the PUA shipping server understands the request 206. Optionally, the shipper may also send its name or ID (for instance, to verify if it is a contact on the user's list). Once the PUA shipping server receives the information, it converts the request into a database query, typically using the SQL computer language 208. The server first checks to see if it has an entry for the PUA. If it does not, it returns an error or NULL to the server which then sends the information back to the requesting shipping computer. If it does have a PUA entry in the database, the system then checks to see if the PIN (if sent in the request) is valid against the PIN associated with that PUA. If it is, then the appropriate physical address is returned to the server which then sends it along to the shipper's computer 210. If the request also included the shipper's name or ID, this is checked against the contacts list associated with the PUA in the database. If the shipper is on the contacts list, the physical address is returned to the server which then sends it along to the shipper's computer. If the PUA exists in the database but requires either a PIN or the requester to be on the contacts list or both, then the server notifies the requester that the PUA is private and access is restricted. Of course, the user may set up the PUA so that anyone can use it and the requester does not need to supply a PIN or be a contact to retrieve the physical address. When retrieving the physical address, the database applies any rules associated with the PUA to insure that the correct physical address is returned to the shipper. Once the shipper has acquired the physical address, it can print up a valid address label using the physical address received and ship the package using the post office or any other package handler.

In an embodiment of the present invention, the user may when arranging a shipment give the retailer the PUA and then specify a trusted shipper like FedEX or UPS. The retailer may then give the package to the trusted shipper and then the trusted shipper retrieves the physical address.

In an embodiment of the present invention, in FIG. 3, a specialized client device 300 for shipping and/or accessing virtual addresses is shown. This specialized client device 300 includes a microprocessor 302. The microprocessor 302 is connected to memory 304, a display 306, a user interface 308, and a network connection 310. The microprocessor 302 may be connected to a printer 312 via a network connection 310.

In an embodiment of the present invention, in FIG. 4, a specialized system for integrating access to shipping and/or accessing virtual addresses is shown 400. This specialized system 400 provides an API 410 connecting a data cluster 412 and third party shippers 408. The API 410 is further connected to the internet 406 both directly and via a web application 414. The web application 414 is further connected to the internet 406. The API 410 can be further accessed via client devices [402, 404] connected to the internet 406, including mobile devices 402 and client computers 404.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A method comprising:
receiving from a recipient at least one physical address and a personal universal address at a server connected to a network and storing the at least one physical address and the personal universal address in a database;
receiving a request from a shipper for the physical address of the recipient using the personal universal address in the request sent over the network to the server; and
transmitting the correct physical address retrieved from the database to the shipper, wherein the server retrieves the correct physical address from the at least one physical address stored in the database using rules stored at the server or in the database.

2. The method of claim 1 wherein the rules comprise date ranges for when a certain physical address associated with the personal universal address is to be transmitted.

3. The method of claim 1 wherein the rules comprise retrieving a different physical address based on the identity of the shipper.

4. The method of claim 1 wherein the shipper is verified as an authorized shipper by looking up the shipper's identity in a table of authorized shippers associated with the universal personal address.

5. The method of claim 1 wherein the universal personal address is a vanity address.

6. The method of claim 1 wherein the universal personal address is an email address.

7. A system comprising:
a server;
at least one recipient device;
at least one shipper device;
a network connecting the server, the at least one recipient device, and the at least one shipper device to facilitate electronic communication;
wherein the server receives from the recipient device at least one physical address and a personal universal address over the network and stores the at least one physical address and the personal universal address in a database;
wherein the server receives a request from the shipper device for the physical address of the recipient using the personal universal address in the request sent over the network;
wherein the server transmits the correct physical address retrieved from the database to the shipper device after the shipper has been authenticated and verified as an authorized shipper by the server after the server retrieves the correct physical address from the at least one physical address stored in the database using rules stored at the server or in the database.

8. A method comprising:
storing a personal universal address received over a network connection into a database;
storing one or more physical addresses associated with the personal universal address into the database;
inputting at least one trusted contact into the database; and
refusing any changes to either the personal universal address, one or more physical addresses, or at least one trusted contact without first receiving a correct password associated with the personal universal address.

9. The method of claim 8 wherein the personal universal address, one or more physical addresses, and at least one password are received by the database through a web server.

10. The method of claim 8 wherein the database also stores a security code associated with the personal universal address.

11. The method of claim 8 further comprising:
receiving a request for a physical address with the personal universal address included in the request;
looking up the at least one physical address; and
sending the physical address to the device that sent the request to the network.

12. The method of claim 11 wherein the database also stores a security code associated with the personal universal address.

13. The method of claim 12 wherein the request for a physical address with the personal universal address included in the request also includes the security code.

14. The method of claim 11 wherein the request for a physical address with the personal universal address included in the request also includes the name of the requester.

15. The method of claim 14 wherein the physical address is only sent to the requesting device if the name of the requestor is a trusted contact associated with the personal universal address.

16. The method of claim 8 further comprising storing rules regarding when to return certain physical addresses.

17. The method of claim 8 wherein the trusted contacts are inputted by either text or by selecting them from a list.

18. The method of claim 8 wherein the trusted contacts are imported from a contacts program.

19. The method of claim 8 wherein the trusted contacts are imported from a social network.

20. The method of claim 1 wherein the universal personal address is an telephone number.
